(19) United States
(12) Patent Application Publication
(10) Pub. No.: US 2025/0231068 A1
(43) Pub. Date: Jul. 17, 2025

(54) TEMPERATURE MEASURING DEVICE AND FURNACE INCLUDING THE SAME

(71) Applicant: Illinois Tool Works Inc., Glenview, IL (US)

(72) Inventors: Yuexin CHEN, Suzhou Jiangsu (CN); Zhixue LIU, Suzhou Jiangsu (CN)

(21) Appl. No.: 18/844,723

(22) PCT Filed: Mar. 16, 2023
(86) PCT No.: PCT/US2023/064556

§ 371 Date: Sep. 6, 2024

(30) Foreign Application Priority Data
Mar. 18, 2022 (CN) 202210272553.7

(51) Int. Cl. G01J 5/05; F27B 9/12; F27D 21/00; F27D 21/02; G01J 5/00; G01J 5/02; G01J 5/08

(52) U.S. Cl. CPC G01J 5/051; F27D 21/0014; G01J 5/0044; G01J 5/0205; G01J 5/0859; F27B 9/12; F27D 2021/026; F27M 2003/04; G01J 2005/0077

(57) ABSTRACT

The present disclosure discloses a temperature measurement device for detecting the temperature of a processing element, wherein the top wall of the furnace has a furnace chamber top opening, comprising: a temperature detection component configured to detect the temperature of the processing element; a support shroud; and a sealing isolation device connected to the support shroud; wherein the temperature detection component is supported over the support shroud, the sealing isolation device configured to sealingly enclose the shroud cavity from above so that the temperature detection component can be isolated from gas within the furnace chamber. The temperature measurement device of the present disclosure can prevent environmental pollution caused by the outflow of high-temperature gas by providing a sealing isolation device, and better prevent the impact of high-temperature gas on the infrared camera, thereby providing better protection.

### TECHNICAL FIELD

The present disclosure relates to a furnace, in particular to a furnace comprising a temperature measurement device.

### BACKGROUND

In some furnaces comprising a heating zone and a cooling zone, the processing element absorbs heat in the heating zone and cold in the cooling zone to complete various processing processes. Photovoltaic devices, such as crystalline silicon-based solar cell silicon wafers, complete the sintering process in a sintering furnace, and the circuit board goes through the welding process in a reflow furnace to weld electronic components to the circuit board. In these furnaces, the amount of heat or cold absorbed by the processing element needs to be accurately controlled.

### SUMMARY

At least one objective of the present disclosure in a first aspect is to provide a temperature measurement device for detecting the temperature of a processing element in a furnace chamber of a furnace wherein the top wall of the furnace has a furnace chamber top opening, comprising: a temperature detection component configured to detect the temperature of the processing element; a support shroud for supporting on the top wall around a furnace chamber top opening of the furnace, the support shroud having a shroud cavity within it in communication with the furnace chamber through the furnace chamber top opening; and a sealing isolation device connected to the support shroud; wherein the temperature detection component is supported over the support shroud, the sealing isolation device configured to sealingly enclose the shroud cavity from above so that the temperature detection component can be isolated from gas within the furnace chamber.

According to the first aspect described above, the support shroud has a shroud top opening and a shroud bottom opening, the shroud top opening and the shroud bottom opening being in communication through the shroud cavity; the sealing isolation device being connected to the top of the support shroud and sealingly enclosing the shroud top opening to isolate the temperature detection component from gas within the furnace chamber.

According to the first aspect described above, the temperature detection component comprises an infrared camera; specifically, the support shroud and the sealing isolation device are configured to support the infrared camera to reach a preset height spaced from a top wall of the furnace to provide a detection field of view of the temperature of the processing element by the infrared camera through the shroud cavity and the furnace chamber top opening.

According to the first aspect described above, the sealing isolation device comprises: a mount connected to a top of the support shroud; a light-transmitting glass connected to the mount, and the light-transmitting glass configured to enclose the shroud top opening; a sealing cover provided above the light-transmitting glass and connected to the mount to sandwich the light-transmitting glass between the mount and the sealing cover.

According to the first aspect described above, the sealing isolation device further comprises a cleaning gas guide configured to direct the cleaning gas to blow towards a lower surface of the light-transmitting glass.

According to the first aspect described above, the cleaning gas guide includes a cleaning gas channel having at least one cleaning gas inlet and at least one cleaning gas outlet configured to direct a cleaning gas blowing to a lower surface of the light-transmitting glass to form a gas curtain.

According to the first aspect described above, the mount includes a mounting plate provided with a mounting plate window and a receiving channel for receiving the cleaning gas guide, a top of the cleaning gas guide being spaced a distance from a lower surface of the light-transmitting glass to form at least one cleaning gas outlet.

According to the first aspect described above, the sealing cover includes a sealing gasket and a cover plate, the sealing gasket being provided above the mount, the cover plate being connected above the sealing gasket, wherein the sealing gasket and the cover plate are provided with a sealing gasket window and a cover plate window, respectively, the sealing gasket window and the cover plate window are aligned with the light-transmitting glass to allow the detection field of view of the infrared camera.

According to the first aspect described above, the mounting plate includes a light-transmitting glass receiving groove formed downward from an upper surface of the mounting plate, the light-transmitting glass being received within the light-transmitting glass receiving groove; the mounting plate further includes a hole disposed below the light-transmitting glass receiving groove and a partition, the partition separating the hole to form the mounting plate window and the receiving channel.

According to the first aspect described above, the partition is supported on the support shroud and a slit is formed between an upper surface of the partition and the light-transmitting glass, wherein the cleaning gas guide is configured to direct cleaning gas to blow through the slit towards a lower surface of the light-transmitting glass.

According to the first aspect described above, the temperature measurement device further comprises a sewer bracket connected at a shroud bottom opening of the support shroud, wherein an outer surface of the top of the sewer bracket and an inner surface of the support shroud have at least one sewer between the sewer bracket provided to direct contaminants attached to the inner surface of the support shroud to be discharged along the outer surface of the sewer bracket to avoid contamination of the processing element by the contaminants.

According to the first aspect described above, the bottom of the support shroud includes a straight wall, and the sewer bracket includes a receiving segment disposed inside the support shroud and a discharge segment extending outwardly out of the support shroud, the top of the receiving segment and the straight wall spaced apart forming the sewer to receive the contaminants.

According to the first aspect described above, the sewer bracket is disposed about the shroud bottom opening and supported in the furnace chamber.

At least one object in a first aspect of the present disclosure is to provide a furnace, comprising: a furnace chamber comprising a heating zone and a cooling zone; a conveying device disposed within the furnace chamber and extending in a conveying direction, the conveying device configured to convey a processing element through the heating zone and the cooling zone; and at least one temperature measurement device according to any one of the first aspects, the temperature measurement device configured to detect the temperature of the processing element within the furnace chamber.

According to the second aspect described above, the furnace is a sintering furnace, the furnace chamber of the sintering furnace comprising a drying zone, a sintering zone, and a cooling zone, wherein the temperature measurement device is provided at an outlet of the drying zone and/or an outlet of the sintering zone.

Other objects and advantages of the present application will be apparent from the description of the present application hereinafter with reference to the accompanying drawings, and may help with a full understanding of the present disclosure.

### BRIEF DESCRIPTION OF DRAWINGS

FIG. 1 is a perspective view of a sintering furnace according to one example of the present disclosure;

FIG. 2 is a schematic diagram of the sintering furnace shown in FIG. 1;

FIG. 3A is a perspective view of the furnace chamber and temperature measurement device of FIG. 1;

FIG. 3B is a partially exploded view of FIG. 3A;

FIG. 4 is a cross-sectional view of the furnace chamber and temperature measurement device of FIG. 1 along the width of the furnace chamber;

FIG. 5A is a perspective view of the temperature measurement device after the temperature detection component in FIG. 1 is eliminated;

FIG. 5B is an exploded view of FIG. 5A;

FIG. 5C is a cross-sectional view of FIG. 5A along the width of the furnace chamber;

FIG. 5D is a cross-sectional view of FIG. 5A along the length of the furnace chamber;

FIG. 6A is a perspective view of the temperature measurement device according to another example of the present disclosure;

FIG. 6B is a cross-sectional view of the temperature measurement device after temperature detection component shown in FIG. 6A is eliminated;

FIG. 6C is an exploded view of FIG. 6A;

FIG. 7 is a structural diagram of a controller according to one example of the present disclosure;

FIG. 8 is a method flow diagram of processing element according to one example of the present disclosure.

### DETAILED DESCRIPTION

Various specific embodiments of the present disclosure will be described below with reference to the attached drawings that form a part of the present specification. It should be understood that while terms denoting orientation, such as “front,” “rear,” “upper,” “lower,” “left,” “right,” “top,” “bottom,” “inside,” “outside,” etc., are used in the present disclosure to describe various exemplary structural parts and elements of the present disclosure, these terms are used herein for convenience of illustration only and are determined based on the exemplary orientations shown in the attached drawings. Since the examples disclosed in the present disclosure may be disposed in different orientations, these terms denoting orientation are for illustrative purposes only and should not be considered as limiting.

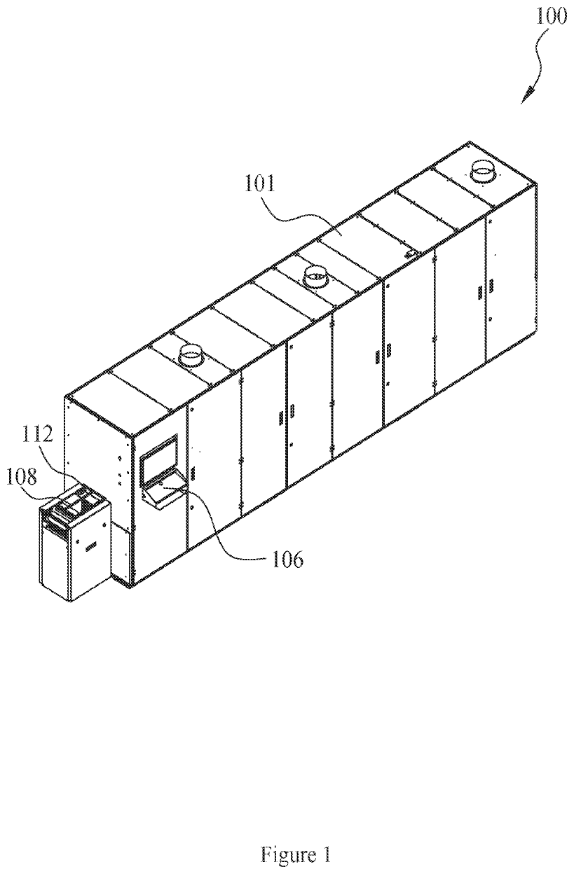

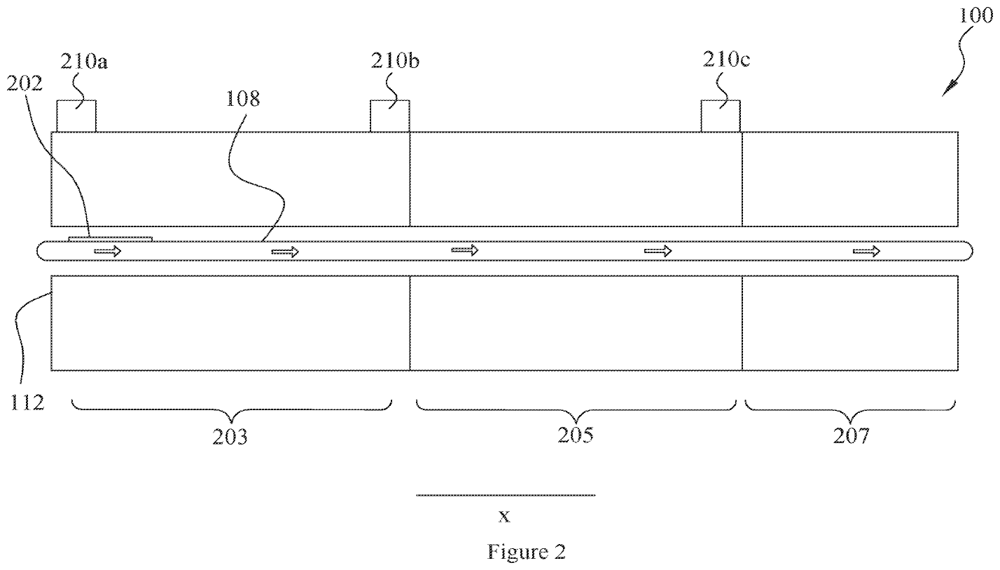

FIG. 1 is a perspective view of a sintering furnace 100 for illustrating an exterior structure of the sintering furnace 100, in accordance with one example of the present disclosure. As shown in FIG. 1, the sintering furnace 100 includes a housing 101, a furnace chamber 112, and a conveying device 108. The furnace chamber 112 is disposed within the housing 101, extending along the length of the sintering furnace 100 and through the housing 101. The conveying device 108 is used for carrying and moving the processing element 202 (see FIG. 2) in the furnace chamber 112 along the conveying direction to complete various processing processes of the processing element 202. In the present example, the conveying device 108 extends along the length direction of the sintering furnace 100 and through the furnace chamber 112, and the conveying direction is the length direction of the sintering furnace 100. The processing element 202 enters the furnace chamber 112 from one end in the length direction of the sintering furnace 100 and is outputted from the other end in the length direction of the sintering furnace 100 after various processing processes are completed in the furnace chamber 112. For ease of description below, the length direction of the sintering furnace 100 is simply referred to as the length direction and the width direction of the sintering furnace 100 is simply referred to as the width direction.

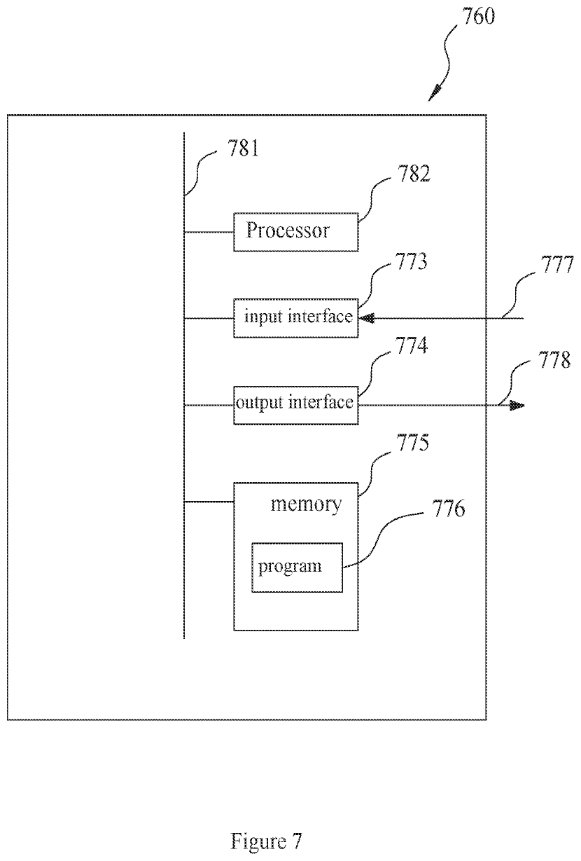

The sintering furnace 100 also includes a display device 106 for communicatively connecting with a controller 760 (see FIG. 7) of the sintering furnace 100 to enable input and output control of the sintering furnace 100.

FIG. 2 is a schematic diagram of a sintering furnace 100 for illustrating various processes of the sintering furnace 100 for the processing element 202. As shown in FIG. 2, the furnace chamber 112 of the sintering furnace 100 includes a plurality of processing zones featuring a heating zone and a cooling zone 207 arranged side by side along the length direction L, and the heating zone in this example includes a drying zone 203 and a sintering zone 205. The processing element 202 is carried on the conveying device 108, being outputted from the right end of the furnace chamber 112 after passing through the drying zone 203, the sintering zone 205, and the cooling zone 207 sequentially along the length direction L from the left end of the furnace chamber 112. Heating elements (not shown in the figures) are provided in the drying zone 203 and the sintering zone 205 to heat the processing element 202 being conveyed into the drying zone 203 and the sintering zone 205. Cooling elements (not shown in the figures) are provided in the cooling zone 207 to cool the processing element 202 being conveyed into the cooling zone 207.

In the present example, the processing element 202 is a photovoltaic device. In the drying zone 203, the photovoltaic device absorbs heat for drying to enable volatilization of organic matter or the like in the paste printed on the photovoltaic device. In the sintering zone 205, the photovoltaic device continues to absorb heat for sintering so that the electrode materials and silicon on the photovoltaic device are heated to a eutectic temperature, and the silicon atoms are dissolved in proportion into the molten electrode materials. In the cooling zone 207, the silicon atoms dissolved in the electrode materials are re-crystallized in a solid form such that an ohmic contact is formed between the electrode and the silicon, resulting in a solar cell.

The sintering furnace 100 also includes at least one temperature measurement device for detecting the temperature of the photovoltaic device when conveyed to a certain determined location within the furnace chamber 112 and providing temperature data to the controller 760 (see FIG. 7). As one example, the at least one temperature measurement device comprises a plurality of temperature measurement devices configured to detect the temperature of the photovoltaic device at two or more independent locations in the selected processing zones in the furnace chamber 112. In the present example, the selected treatment zones comprise a drying zone 203 and a sintering zone 205, the plurality of temperature measurement devices comprising a temperature measurement device 210a disposed at an inlet of the drying zone 203, a temperature measurement device 210b disposed at an outlet of the drying zone 203, and a temperature measurement device 210c disposed at an outlet of the sintering zone 205. By providing temperature measurement devices 210a, 210b, and 210c, the temperature of the photovoltaic device at the inlet of the drying zone 203, at the outlet of the drying zone 203, and at the outlet of the sintering zone 205 can be obtained. In other examples, the selected processing zones may also comprise a cooling zone 207, and the number of temperature measurement devices may also comprise more temperature measurement devices to determine the temperature of the photovoltaic device when the photovoltaic device is conveyed to more locations of the furnace chamber 112. In some examples, the temperature measurement device may include only the temperature measurement devices 210b and 210c, but without the temperature measurement device 210a.

Based on the temperature data detected and provided by the temperature measurement devices 210a, 210b, and 210c, the controller 760 is capable of providing closed loop control of the temperature of various processing zones of the sintering furnace 100. As one example, closed loop control may comprise a control method such as controlling the power of the heating element and/or cooling element, the conveying speed of the conveying device, etc. In particular, the controller 760 is configured to compare the temperature data of the photovoltaic device detected by the temperature measurement device to the preset temperature values of the respective processing zones and to provide closed loop control of the temperature of the respective processing zones according to the comparison results. As one specific example, the preset temperature value in the drying zone 203 is about 300° C. If the temperature data detected by the temperature measurement device 210b is greater than 300° C., the power of the heating element in the drying zone 203 is reduced or the conveying speed of the conveying device 108 is increased. If the temperature data detected by the temperature measurement device 210b is less than 300° C., the power of the heating element in the drying zone 203 is increased or the conveying speed of the conveying device 108 is reduced. Similarly, the temperature data detected by the temperature measurement device 210c is similarly compared to the preset temperature values of the sintering zone 205 and the temperature of the sintering zone 205 is closed loop controlled according to the comparison results.

It can be understood by those skilled in the art that although the temperature measurement device shown in this example is used for temperature detection of photovoltaic devices in a sintering furnace, in other examples, the temperature measurement device may also be used for temperature detection of circuit boards in a reflow furnace, a wave soldering furnace, etc. Depending on the particular furnace, a temperature measurement device may be provided at different locations to detect the temperature of the processing element at the desired location.

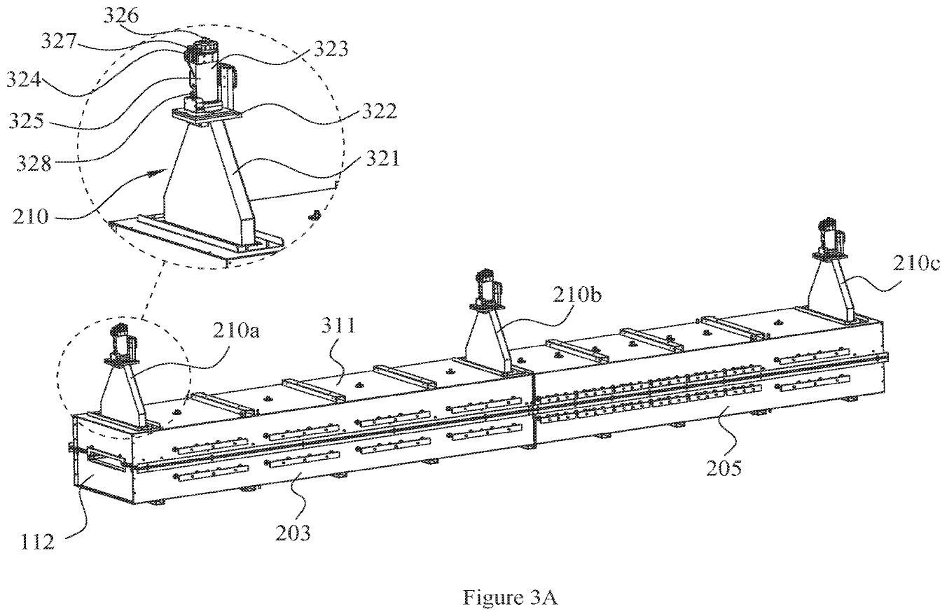

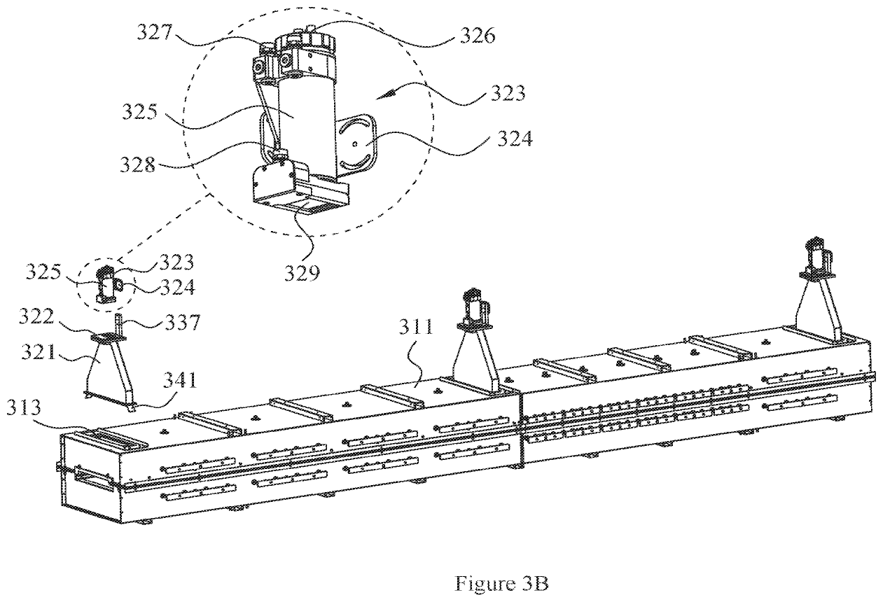

FIGS. 3A and 3B illustrate a furnace chamber 112 and a temperature measurement device 210 for illustrating the general structure of the temperature measurement device 210 and the specific structure of the temperature detection component 323. FIG. 3A shows a perspective view of the furnace chamber 112 and the temperature measurement device 210, and FIG. 3B shows a partial exploded view of FIG. 3A at the temperature measurement device 210. Wherein, the cooling zone 207 of the sintering furnace 100 is eliminated in the furnace chamber 112 in FIGS. 3A and 3B, and only the drying zone 203 and the sintering zone 205 are shown. As shown in FIGS. 3A and 3B, the top wall 311 of the furnace chamber 112 is provided with a furnace chamber top opening 313, which is generally rectangular. Through the furnace chamber top opening 313, the interior of the furnace chamber 112 is in fluid communication with the exterior of the furnace chamber.

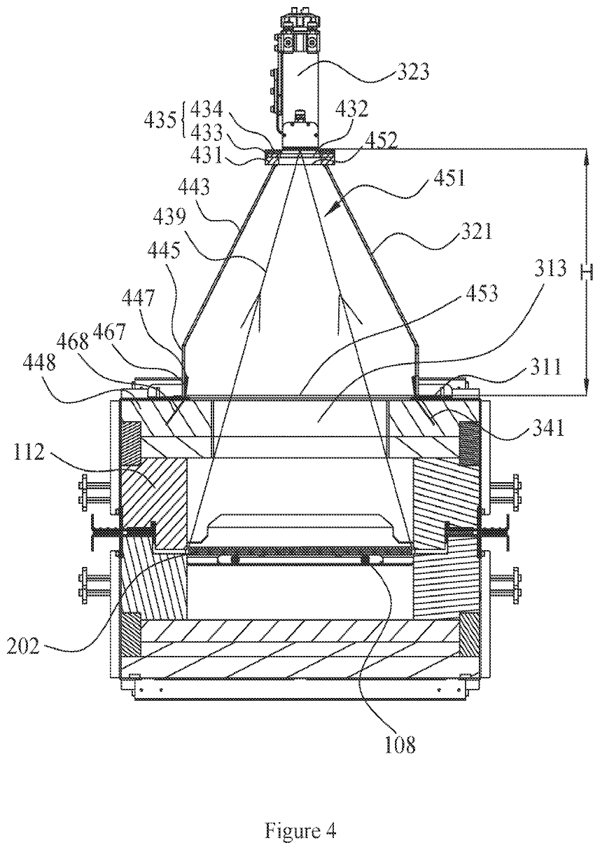

The temperature measurement device 210 includes a temperature detection component 323, a sealing isolation device 322, and a support shroud 321. The support shroud 321 is supported above the top wall 311 around the furnace chamber top opening 313. Internally, the support shroud 321 has a shroud cavity 451 (see FIG. 4) in fluid communication with the interior of the furnace chamber 112 through the furnace chamber top opening 313. The temperature detection component 323 is connected over the support shroud 321, which detects the temperature of the photovoltaic device inside the furnace chamber 112 through the shroud cavity 451 and the furnace chamber top opening 313. The sealing isolation device 322 is disposed between the temperature detection component 323 and the furnace chamber top opening 313 to enable the temperature detection component 323 to be isolated from the atmosphere within the furnace chamber 112 by the sealing isolation device 322. In the present example, the temperature detection component 323 includes an infrared camera 325 and a camera holder 324 wherein the infrared camera 325 is mounted to the camera holder 324. The sealing isolation device 322 includes a light-transmitting glass 432 (see FIG. 4) capable of blocking the passage of gas in the furnace chamber 112 while allowing infrared light transmission. As such, the infrared camera 325 can receive infrared radiation from the photovoltaic device inside the furnace chamber 112 by sealing the light-transmitting glass 432, the shroud cavity 451, and the furnace chamber top opening 313 of the sealing isolation device 322, thereby detecting the temperature of the photovoltaic device. In the present example, the infrared camera 325 is a linear scanning infrared camera 325. When the photovoltaic device is conveyed along the length direction by the conveying device 108, the temperature of the photovoltaic device in each width direction is obtained by scanning the infrared radiation of the photovoltaic device in each width direction, thereby obtaining the temperature data of the photovoltaic device. The infrared camera 325 includes a communication interface 326 for communication with the controller 760 to communicate temperature data of the photovoltaic device detected by the infrared camera 325 to the controller 760.

In the present example, the sealing isolation device 332 is connected at the top of the support shroud 321 and encloses the shroud top opening 452 of the support shroud 321 (see FIG. 4). The sealing isolation device 322 also includes a mounting lever 337 extending upwardly from its bottom for connecting the camera holder 324 to the sealing isolation device 322 to mount the infrared camera 325 over the sealing isolation device 322. In other examples, the sealing isolation device 322 may also be connected in other locations of the support shroud 321, only between the temperature detection component 323 and the furnace chamber top opening 313.

The camera holder 324 includes a water-cooling device 327, a cover 329, and a gas cooling device 328. The water-cooling device 327 is in fluid communication with the cooling water source, which surrounds the infrared camera 325 and is disposed on top of the infrared camera 325 for directing the flow of cooling water to cool the infrared camera 325. The cover 329 is an infrared light-transmitting glass disposed below the infrared camera 325 to protect the infrared camera 325 from below. The gas cooling device 328 is provided at the bottom of the infrared camera 325 for fluid communication with a cooling gas source, such as an inert gas source or a compressed gas source, for directing the cooling gas to blow towards the lower surface of the cover 329 for cleaning and cooling the cover 329. As such, the camera holder 324 is capable of protecting the infrared camera 325 to some extent.

The gas temperature in the furnace chamber 112 of the sintering furnace 100 is higher; particularly, the gas temperature in the sintering zone 205 may reach about 1,000-2,000° C., and the gas in the furnace chamber 112 is often also entrained with contaminants. While the camera holder 324 can be able to protect the infrared camera 325 to some extent, the camera holder 324 has limited protection against the infrared camera 325 when the gas temperature in the furnace chamber 112 is too high. Furthermore, the camera holder 324 needs to match the structure and shape of the infrared camera 325, making it less adaptable. By providing a sealing isolation device 332, the present disclosure can prevent gas inside the furnace chamber 112 from flowing out of the shroud top opening 452 of the support shroud 321, prevent environmental contamination caused by high-temperature gas flowing out, and better prevent high-temperature gas from affecting the infrared camera 325, thereby providing better protection. Furthermore, the sealing isolation device 332 does not need to be limited by the shape and structure of the infrared camera 325 for greater applicability.

The temperature measurement device 210 also includes a sewer bracket 341 connected to the bottom of the support shroud 321 and dilated outward in a width direction from the bottom edge of the support shroud 321. The sewer bracket 341 is used for directing the discharge of contaminants attached to the inner surface of the support shroud 321 to avoid contamination of the photovoltaic device. The specific structure of the sewer bracket 341 will be described in detail in connection with FIG. 4.

FIG. 4 is a partial cross-sectional view of the furnace chamber 112 and the

temperature measurement device 210 in one width direction for illustrating the principle of detecting the temperature of the processing element 202 by the temperature detection component 323, in which the temperature detection component 323 is not cut. As shown in FIG. 4, the support shroud 321 has a shroud cavity 451 within it that forms a shroud top opening 452 at the top of the support shroud 321 and a shroud bottom opening 453 at the bottom of the support shroud 321; that is, the shroud top opening 452 and the shroud bottom opening 453 are in communication through the shroud cavity 451. The support shroud 321 and the sealing isolation device 322 are configured to support the infrared camera 325 to reach a preset height H spaced from the top wall 311 to provide a detection field of view of the infrared camera 325 to detect the temperature of the processing element 202 through the shroud cavity 451 and the furnace chamber top opening 313. In the present example, the infrared radiation of the processing element 202 in the width direction is received by the infrared camera 325 of the temperature detection component 323 after passing through the furnace chamber top opening 313, the shroud cavity 451, and the light-transmitting glass 432 along the light path 439. When the processing element 202 is conveyed along the length direction by the conveying device 108, the temperature detection component 323 is capable of scanning the temperature in various width directions of the processing element 202 to obtain temperature data of the processing element 202.

The support shroud 321 includes a pair of side walls disposed oppositely in a width direction, each side wall comprising a mutually connected beveled wall 443 and a straight wall 445. The bottom of the straight wall 445 is connected with the top wall 311 of the furnace chamber 112, the beveled wall 443 extending upwardly and oppositely from the top of the straight wall 445. As such, the shroud cavity 451 inside the support shroud 321 can provide the detection field of view needed for the infrared camera 325 to receive the light path 439. In some examples, the support shroud 321 may also be provided in other shapes, only to ensure that the shroud cavity 451 can provide the detection field of view required by the infrared camera 325 with the furnace chamber top opening 313.

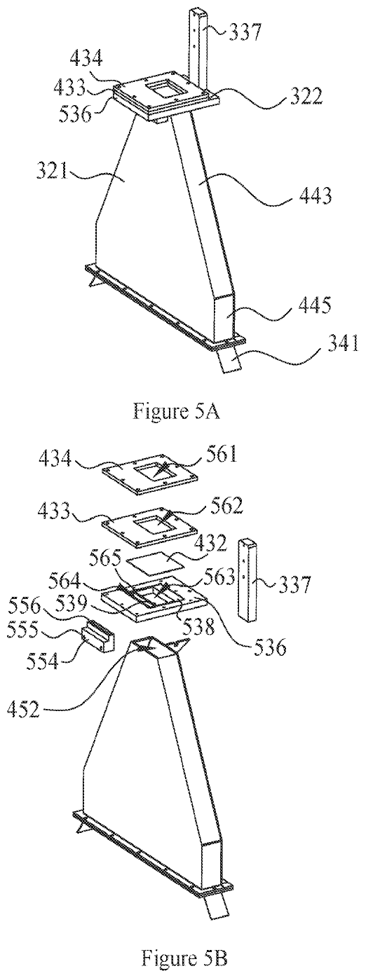

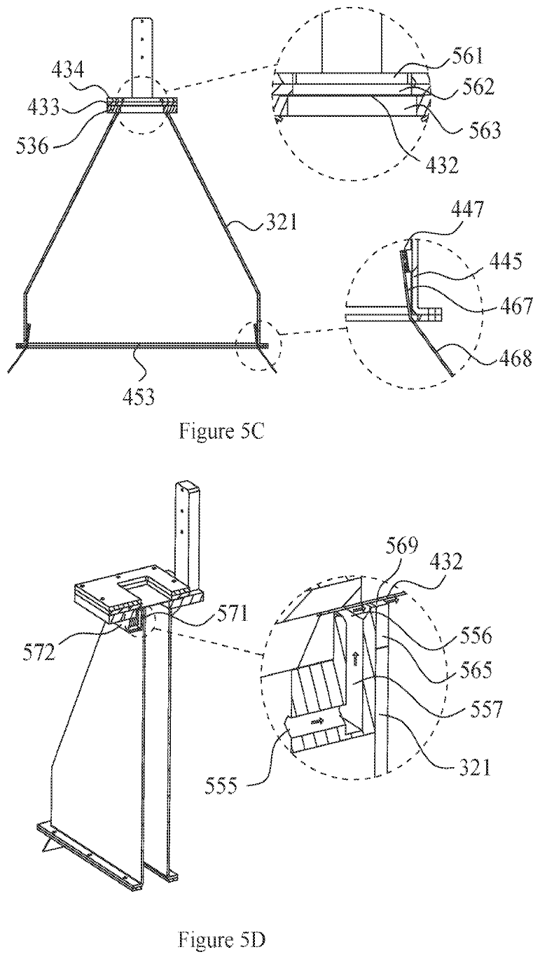

The sealing isolation device 332 includes a mount 431, a light-transmitting glass 432, and a sealing cover 435. The mount 431 is connected at the top of the support shroud 321 and the sealing cover 435 is connected above the mount 431. The sealing cover 435 includes a sealing gasket 433 and a cover plate 434, the light-transmitting glass 432 being sandwiched between the mount 431 and the sealing gasket 433 of the sealing cover 435, the cover plate 434 being overlying the sealing gasket 433. A more specific structure of the sealing isolation device 332 will be detailed in connection with FIGS. 5A and 5B.

The sewer bracket 341 is connected at the shroud bottom opening 453 of the support shroud 321. The outer surface of the top of the sewer bracket 341 and the inner surface of the support shroud 321 are spaced to form at least one sewer 447 through which contaminants attached to the inner surface of the support shroud 321 can be expelled. In the present example, the sewer bracket 341 includes a receiving segment 467 disposed inside the support shroud 321 and a discharge segment 468, and a sewer 447 is formed between the top of the receiving segment 467 and the straight wall 445 of the support shroud 321. The discharge segment 468 extends outwardly from the bottom of the receiving segment 467 into the insulation layer 448 of the furnace chamber 112. As one example, the sewer bracket 341 is formed by an integrated bending process and the sewer bracket 341 is connected to the support shroud 321 through its top. In other examples, the sewer bracket 341 may also be provided in other shapes, or other parts of the sewer bracket 341 may be connected with the support shroud 321. By providing a sewer bracket 341 at the bottom of the support shroud 321, after the high temperature gas in the furnace chamber 112 enters the shroud cavity 451, contaminants entrained in the high temperature gas can condense or attach directly to the inner surface of the support shroud 321, and then be discharged into the insulation layer 448 of the furnace chamber 112 along the outer surface of the sewer bracket 341 through the sewer 447. As such, contaminants do not fall directly from the furnace chamber top opening 313 onto the processing element 202.

FIGS. 5A-5D illustrate specific structures of the temperature measurement device after eliminating the temperature detection component, wherein FIG. 5A illustrates a perspective view of the sewer bracket 341, the support shroud 321, and the sealing isolation device 322, FIG. 5B illustrates an exploded view of the sealing isolation device 322 in FIG. 5A, FIG. 5C illustrates a cross-sectional view of FIG. 5A along the width direction, and FIG. 5D illustrates a cross-sectional view of FIG. 5A along the length direction. As shown in FIGS. 5A-5D, the mount 431 of the sealing isolation device 332 includes a mounting plate 536 and a mounting lever 337, wherein the mounting level 337 is connected on an upper surface of the mounting plate 536 for connection with the temperature detection component 323. The central portion of the mounting plate 536 is provided with a light-transmitting glass receiving groove 538 that is recessed downwardly from the upper surface of the mounting plate 536. The groove depth of the light-transmitting glass receiving groove 538 generally matches the thickness of the light-transmitting glass 432 to enable the light-transmitting glass 432 to be received within the light-transmitting glass receiving groove 538.

The mounting plate 536 is provided with a mounting plate window 563 below the light-transmitting glass receiving groove 538. Similarly, a sealing gasket window 562 is provided at a corresponding location on the sealing gasket 433 and a cover plate window 561 is provided at a corresponding location on the cover plate 434. The mounting plate window 563, the sealing gasket window 562, and the cover plate window 561 are aligned with the light-transmitting glass 432 to give the detection field of view of the temperature detection component 323 and to allow the infrared radiation formed by the processing element 202 to be received by the infrared camera 325 of the temperature detection component 323 after passing through the mounting plate window 563, the light-transmitting glass 432, the sealing gasket window 562, and the cover plate window 561 sequentially.

In this example, the mounting plate 536 is provided with a hole 539 and a partition 565 below the light-transmitting glass receiving groove 538, and the partition 565 divides the hole 539 into a mounting plate window 563 and a receiving channel 564 side by side in the length direction. The hole 539 is larger in size than the sealing gasket window 562 and the cover plate window 561, but smaller in size than the light-transmitting glass receiving groove 538. As such, the sealing gasket 433 is capable of blocking gas leakage in the shroud cavity 451 in communication with the furnace chamber 112 from above the light-transmitting glass 432.

The sealing isolation device 322 also includes a cleaning gas guide 554 for directing the cleaning gas to blow towards the lower surface of the light-transmitting glass 432. The cleaning gas guide 554 is generally corner-shaped with a longitudinal portion 571 and a transverse portion 572 generally perpendicular to and interconnected with each other. The longitudinal portion 571 of the cleaning gas guide 554 is sandwiched between the hole 539 and the partition 565 and received in the receiving channel 564, and the top of the longitudinal portion 571 is spaced a distance from the light-transmitting glass 432. The transverse portion 572 of the cleaning gas guide 554 is connected below the mounting plate 536 and substantially parallel to the mounting plate 536. A cleaning gas channel 557 is provided in the cleaning gas guide 554 having at least one cleaning gas inlet 555 and at least one cleaning gas outlet 556. In the present example, the cleaning gas channel 557 has two cleaning gas inlets 555 and one cleaning gas outlet 556, a portion of the cleaning gas channel 557 being disposed within the transverse portion 572 and extending parallel to the transverse portion 572, the other portion being disposed within the longitudinal portion 571 and extending parallel to the longitudinal portion 571. Two clean gas inlets 555 are located outboard of the transverse portion 572, both for fluid communication with an inert gas source or compressed air source to input the clean gas into the clean gas channel 557. The cleaning gas outlet 556 is located at the top of the longitudinal portion 571 and extends in a width direction to communicate with the two cleaning gas inlets 555, and the cleaning gas outlet 556 is spaced a distance from the lower surface of the light-transmitting glass 432 to blow cleaning gas out of the lower surface of the light-transmitting glass 432. As such, after the cleaning gas enters the cleaning gas channel 557 from the cleaning gas inlet 555, it flows transversely, then upwards to the top of the longitudinal portion 571 and blows from the cleaning gas outlet 556 towards the lower surface of the light-transmitting glass 432.

In the present example, the upper surface of the partition 565 is generally aligned with the height of the top of the longitudinal portion 571 and the sides are aligned with the support shroud 321. That is, the upper surface of the partition 565 is spaced a distance from the lower surface of the light-transmitting glass 432, such as forming a slit 569. By providing the slit 569, the cleaning gas blown out from the cleaning gas outlet 556 can continue to flow along the light-transmitting glass 432 to form a gas curtain, on the one hand for cleaning the lower surface of the light-transmitting glass 432, and on the other hand for preventing gas leakage from under the light-transmitting glass 432. In other examples, the cleaning gas guide 554 may also be provided in other shapes and structures to achieve the same effect.

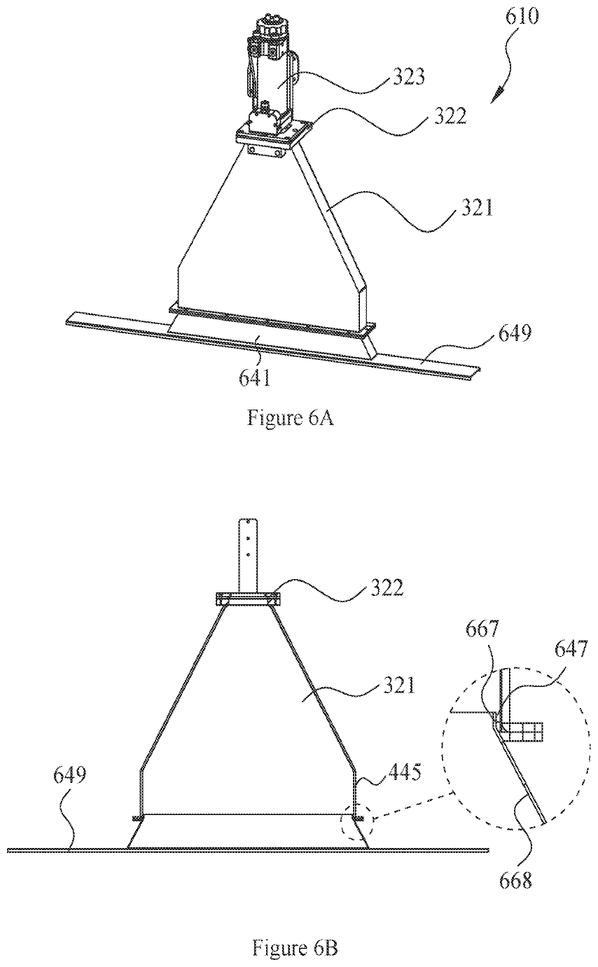

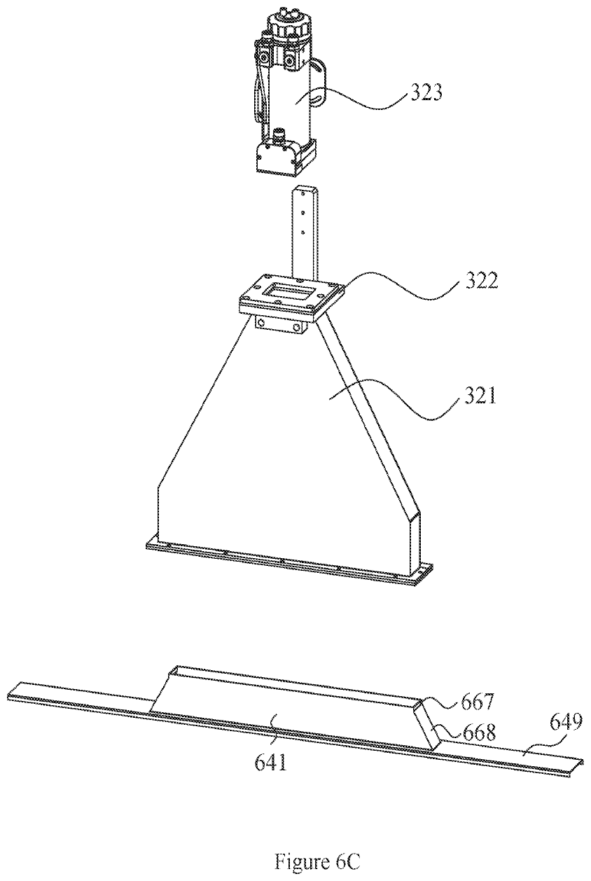

FIGS. 6A-6C show the specific structures of the temperature measurement device 610 in another example of the present disclosure, wherein FIG. 6A is a perspective view of the temperature measurement device 610, FIG. 6B is a cross-sectional view of the temperature measurement device 610 along the width direction after the temperature detection component 323 is eliminated, and FIG. 6C is an exploded view of the temperature measurement device 610. As shown in FIGS. 6A-6C, the structures of the temperature measurement device 610 and the temperature measurement device 210 are generally the same, and both include a temperature detection component 323, a sealing isolation device 322, and a support shroud 321, except that the structure of the sewer bracket 641 in the temperature measurement device 610 is different from the structure of the sewer bracket 341 in the temperature measurement device 210.

In particular, the sewer bracket 641 includes a receiving segment 667 and a discharge segment 668 interconnected with each other, wherein the receiving segment 667 is disposed inside the support shroud 321, and the receiving segment 667 and the straight wall 445 of the support shroud 321 are spaced to form a sewer 647. The discharge segment 668 extends outwardly from the bottom of the receiving segment 667. The bottom of the discharge segment 668 is connected with a support plate 649 into which the discharge segment 668 and the support plate 649 extend into the insulation layer 448 of the furnace chamber 112. In the present example, the sewer bracket 641 is no longer directly connected with the support shroud 321, but rather with the furnace chamber 112 through the support plate 649. When the support shroud 321 is connected to the top wall 311 of the furnace chamber 112, the relative position of the sewer bracket 641 and the support shroud 321 can also be fixed. And in the present example, the receiving segment 667 and the discharge segment 668 are provided as rings so that the sewer bracket 641 is highly stable. Furthermore, in the present example, the receiving segment 667 is substantially parallel to the straight wall 445 to facilitate downward flow of contaminants upon entry from the sewer 647. The sewer bracket 641 in this example provides more convenience for processing and manufacturing than the sewer bracket 341.

FIG. 7 is a schematic block diagram of a controller 760. As shown in FIG. 7, the controller 760 includes a bus 781, a processor 782, an input interface 773, an output interface 774, and a memory 775 featuring a control program 776. Various components of the controller 760, including the processor 782, the input interface 773, the output interface 774, and the memory 775, are in communication with the bus 781 to enable the processor 782 to control the operations of the input interface 773, the output interface 774, and the memory 775. Specifically, the memory 775 is used for storing programs, instructions, and data, while the processor 782 reads programs, instructions, and data from the memory 775 and can write data to the memory 775. By executing the memory 775 to read the programs and instructions, etc., the processor 782 controls the operations of the input interface 773 and the output interface 774.

As shown in FIG. 7, the input interface 773 is communicatively connected with the temperature measurement device 210 and the display device 106 by connection 777 to receive temperature data provided by the temperature measurement device 210 and control instructions received by the display device 106 and store the temperature data and control instructions in the memory 775. The output interface 774 is communicatively connected with the heating element in the furnace chamber 112 of the sintering furnace 100 and the conveying device 108 by connection 778. By executing the program 776 and the received instructions in the memory 775, the controller 760 provides closed loop control of the temperature of various processing zones in the furnace chamber 112.

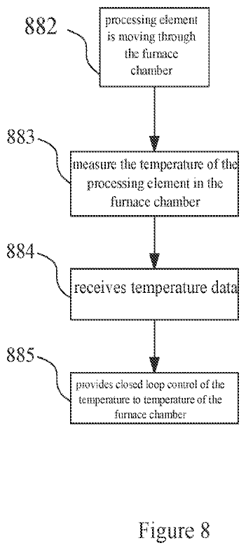

FIG. 8 is a method flow diagram of the processing element according to one example of the present disclosure. As shown in FIG. 8, in step 882, the processing element 202 is controlled to move through various processing zones of the furnace chamber 112 by the conveying device 108.

In step 883, the temperature of the processing element 202 at a respective location in the furnace chamber 112 is detected by the temperature measurement device 210, and the temperature measurement device 210 provides the detected temperature data.

In step 884, the controller 760 receives temperature data provided by temperature measurement device 210.

In step 885, the controller 760 provides closed loop control of the temperature of various processing zones of the furnace chamber according to the temperature data.

In existing sintering furnaces, gas temperatures in various processing zones of the furnace chamber are generally detected by thermal probes, and the settings of the sintering furnace are modified as needed by smart software, etc., to maintain the temperature within the specified range within various processing zones, thereby ensuring the processing yield of the photovoltaic device in the sintering furnace. During the operations of the sintering furnace, if the actual temperature of the photovoltaic device is inconsistent with the gas temperature in various processing zones of the furnace chamber, the heat or cold absorbed by the photovoltaic device in various processing zones of the sintering furnace cannot be accurately controlled, thereby causing the photovoltaic device to be damaged or defective.

The present disclosure directly detects the temperature of the photovoltaic device in the sintering furnace through a temperature measurement device, rather than detecting the temperature of the gas in the sintering furnace, for more directly controlling the amount of heat or cold absorbed by the photovoltaic device in various processing zones of the sintering furnace, thereby improving the yield of the product.

In addition, the temperature measurement device of the present disclosure can prevent gas inside the furnace chamber from flowing out of the shroud top opening of the support shroud by providing a sealing isolation device, prevent environmental pollution caused by high temperature gas flowing out, and better prevent high temperature gas from affecting the infrared camera, thereby providing better protection. In addition, the sealing isolation device does not need to be limited by the shape and structure of the infrared camera, making them more adaptable.

Although the present example has been described in connection with examples of the examples outlined above, various alternatives, modifications, variations, improvements, and/or substantial equivalents, whether known or foreseeable now or in the near future, may be apparent to those having at least ordinary skill in the art. In addition, the technical effects and/or technical problems described in the present specification are exemplary and not limiting; therefore, the disclosure in the present specification may be used to solve other technical problems and have other technical effects and/or may solve other technical problems. Therefore, examples of the present example as set forth above are intended to be illustrative and not limiting. Various changes may be made without departing from the spirit or scope of the present disclosure. Therefore, the present disclosure is intended to include all known or earlier developed alternatives, modifications, variations, improvements and/or substantial equivalents.

1-15. (canceled)

16. A temperature measurement device for detecting the temperature of a processing element in a furnace chamber of a furnace, wherein the top wall of the furnace has a furnace chamber top opening, comprising:
a temperature detection component configured to detect the temperature of the processing element;
a support shroud for supporting on the top wall around a furnace chamber top opening of the furnace, the support shroud having a shroud cavity inside, the shroud cavity communicating with the furnace chamber through the furnace chamber top opening; and
a sealing isolation device connected to the support shroud;
wherein the temperature detection component is supported over the support shroud, the sealing isolation device configured to sealingly enclose the shroud cavity from above such that the temperature detection component can be isolated from gas within the furnace chamber.

17. The temperature measurement device according to claim 16, wherein:
the support shroud has a shroud top opening and a shroud bottom opening, the shroud top opening and the shroud bottom opening communicating through the shroud cavity;
the sealing isolation device is connected to the top of the support shroud and sealingly encloses the shroud top opening to isolate the temperature detection component from gas within the furnace chamber.

18. The temperature measurement device according to claim 17, wherein:
the temperature detection component comprises an infrared camera;
wherein the support shroud and the sealing isolation device are configured to support the infrared camera to reach a preset height (H) spaced from a top wall of the furnace to provide a detection field of view of the temperature of the infrared camera and to detect the processing element through the shroud cavity and the furnace chamber top opening.

19. The temperature measurement device according to claim 18, wherein:
the sealing isolation device comprises:
a mount connected on top of the support shroud;
a light-transmitting glass connected to the mount and configured to enclose the shroud top opening;
a sealing cover provided over the light-transmitting glass and connected with the mount to sandwich the light-transmitting glass between the mount and the sealing cover.

19. The temperature measurement device according to claim 19, wherein:
the sealing isolation device also includes a cleaning gas guide configured to direct the cleaning gas to blow towards a lower surface of the light-transmitting glass.

21. The temperature measurement device according to claim 20, wherein:
the cleaning gas guide includes a cleaning gas channel having at least one cleaning gas inlet and at least one cleaning gas outlet configured to direct the cleaning gas blowing towards a lower surface of the light-transmitting glass to form a gas curtain.

22. The temperature measurement device according to claim 20, wherein:
the mount includes a mounting plate on which a mounting plate window and a receiving channel are disposed, the receiving channel for receiving the cleaning gas guide, the top of the cleaning gas guide spaced a distance from the lower surface of the light-transmitting glass to form at least one cleaning gas outlet.

23. The temperature measurement device according to claim 22, wherein:
the sealing cover includes a sealing gasket and a cover plate, the sealing gasket being disposed over the mount, the cover plate being connected over the sealing gasket, the sealing gasket and the cover plate being provided with a sealing gasket window and a cover plate window, respectively, the sealing gasket window and the cover plate window being aligned with the light-transmitting glass to allow the detection of the infrared camera.

22. The temperature measurement device according to claim 22, wherein:
the mounting plate comprises a light-transmitting glass receiving groove formed downwardly from an upper surface of the mounting plate, the light-transmitting glass being received within the light-transmitting glass receiving groove; and
the mounting plate also includes a hole and a partition disposed below the light-transmitting glass receiving groove, the partition separating the hole to form the mounting plate window and the receiving channel.

25. The temperature measurement device according to claim 24, wherein:
the partition is supported on the support shroud and a slit is formed between an upper surface of the partition and the light-transmitting glass, wherein the cleaning gas guide is configured to direct cleaning gas to blow through the slit to a lower surface of the light-transmitting glass.

17. The temperature measurement device according to claim 17, wherein:
the temperature measurement device also comprises a sewer bracket connected at a shroud bottom opening of the support shroud, wherein an outer surface of a top of the sewer bracket and an inner surface of the support shroud have at least one sewer disposed to direct contaminants attached to an inner surface of the support shroud through the sewer along an outer surface of the sewer bracket to avoid contamination of the processing element.

27. The temperature measurement device according to claim 26, wherein:
the bottom of the support shroud includes a straight wall the sewer bracket comprises a receiving segment disposed inside the support shroud and a discharge segment extending outwardly out of the support shroud, the top of the receiving segment being spaced from the straight wall to form the sewer to receive the contaminants.

27. The temperature measurement device according to claim 27, wherein:
the sewer bracket is disposed around the shroud bottom opening and is supported in the furnace chamber.

29. A furnace comprising:
a furnace chamber, wherein the furnace chamber comprises heating zones and a cooling zone,
a conveying device disposed within the furnace chamber and extending in a conveying direction, the conveying device configured to convey a processing element through the heating zones and the cooling zone; and
at least one temperature measurement device according to claim 1, the temperature measurement device configured to detect the temperature of the processing element within the furnace chamber.

29. The furnace according to claim 29, wherein:
the furnace is a sintering furnace, the furnace chamber of the furnace comprising a drying zone, a sintering zone, and a cooling zone, wherein the temperature measurement device is provided at at least one of an outlet of the drying zone or an outlet of the sintering zone.
